(19) United States
(12) Patent Application Publication
(10) Pub. No.: US 2003/0084588 A1
(43) Pub. Date: May 8, 2003

(54) Methods and systems for drying lipophilic fluid-containing fabrics

(76) Inventors: Paul Amaat Raymond Gerald France, West Chester, OH (US); Anna Vadimovna Radomyselski, Hamilton, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/307,744

(22) Filed: Dec. 2, 2002

Related U.S. Application Data
(63) Continuation of application No. PCT/US02/25887, filed on Aug. 14, 2002.
(60) Provisional application No. 60/312,406, filed on Aug. 15, 2001.

(51) Int. Cl. F26B 3/34

(52) U.S. Cl. 34/245

(57) ABSTRACT

Methods and/or systems for reducing the drying time of lipophilic fluid-containing fabric articles are provided.

### RELATED APPLICATIONS

This application is a continuation of International Application No. PCT/US02/25887 filed Aug. 14, 2002, which claims priority to U.S. Provisional Application Serial No. 60/312,406 filed Aug. 15, 2001.

### FIELD OF THE INVENTION

The present invention relates methods and/or systems for reducing the drying time of lipophilic fluid-containing fabric articles.

### BACKGROUND OF THE INVENTION

Recently, consumers have demanded more from dry cleaning processes. The demands may include the use of solvents with better fabric care profiles. Further, in order to avoid the cost and effort of utilizing a commercial service provider, and in some cases the associated dissatisfaction, some consumers would prefer to have dry-cleaning machines in their home. In this respect, the consumer can dry clean items as needed without leaving home and without waiting for the dry cleaner to return the item.

Conventional dry cleaning apparatuses typically introduce a cleaning fluid that contains little, if any, water. Instead, the predominant fluid is typically a lipophilic fluid, that is, a fluid capable of dissolving sebum and other “oily” soils. Recently, some lipophilic fluids have been identified as having particularly desirable garment care profiles. An example of these lipophilic fluids includes the siloxane based cleaning fluids. Once introduced into the apparatus, the lipophilic fluid typically co-mingles with the fabric load in order to provide cleaning benefits. The garments are then dried in the same apparatus or a separate drying apparatus capable of introducing hot air and tumbling the garments.

While some of these lipophilic fluids are less volatile and hence safer for in-home use, they also tend to have higher boiling points which makes for longer drying times. If a dry cleaning apparatus was introduced into consumers' homes, the consumers would naturally expect the machine to be capable of completing an entire load of clothes, including drying, in about one and one-half hours, much like the aqueous based laundry cycle. However, due to the higher boiling points, and, in some cases, the flammability of some of the preferred lipophilic fluids, this “dry to dry” time limitation may not be feasible.

Accordingly, the need remains for an effective way to attain a shorter drying time after a lipophilic fluid based fabric cleaning cycle.

### SUMMARY OF THE INVENTION

This need is met by the present invention wherein a method for effectively attaining a shorter drying time after a lipophilic fluid based fabric cleaning cycle. In general, the invention utilizes at least one of several ways to “preheat” the fabrics prior to the drying cycle such that no time is wasted heating the fabrics during the drying cycle.

The present invention has two embodiments.

In a first embodiment the present invention provides a method to heat fabrics contacted with a lipophilic fluid to a temperature above ambient temperature, wherein the method includes at least one step from the group of blowing a gas onto said fabrics while spraying a rinse liquor onto and tumbling the fabrics before extraction of the rinse liquor begins; pre-heating a rinse liquor prior to applying the rinse liquor to the fabrics; exposing the fabrics to an electromagnetic energy source while spraying a rinse liquor onto and tumbling the fabrics before extraction of the rinse liquor begins wherein the electromagnetic energy source is selected from the group of infrared light, microwave, and radio frequency; and, combinations of these steps.

In a second embodiment the present invention provides a system for heating fabrics contacted with a lipophilic fluid to a temperature above ambient temperature, the system includes the capability to perform at least one function selected from the group of blowing a gas onto the fabrics while spraying a rinse liquor onto and tumbling the fabrics before extraction of the rinse liquor begins; pre-heating a rinse liquor prior to applying the rinse liquor to the fabrics; and, exposing the fabrics to an electromagnetic energy source while spraying a rinse liquor onto and tumbling the fabrics before extraction of the rinse liquor begins wherein the electromagnetic energy source is selected from the group of infrared light, microwave, and radio frequency.

These and other aspects, features and advantages will become apparent to those of ordinary skill in the art from a reading of the following detailed description and the appended claims. All percentages, ratios and proportions herein are by weight, unless otherwise specified. All temperatures are in degrees Celsius (° C.) unless otherwise specified. All measurements are in SI units unless otherwise specified. All documents, books, articles, and references cited are, in relevant part, incorporated herein by reference.

### DETAILED DESCRIPTION OF THE INVENTION

Definitions

The terms “fabrics,” “fabric articles,” and “fabric load” used herein is intended to mean any article or group of articles that is customarily cleaned in a conventional laundry process or in a dry cleaning process. As such the term encompasses articles of clothing, linen, drapery, and clothing accessories. The term also encompasses other items made in whole or in part of fabric, such as tote bags, furniture covers, tarpaulins and the like.

The term “lipophilic fluid” used herein is intended to mean any non-aqueous fluid capable of removing sebum, as qualified by the test described herein.

The terms “dry”, “drying”, “dried” as they are used in conjunction with the phrase “lipophilic fluid-containing fabric article(s)” is intended to mean that the fabric article is dry to the touch and/or that the fabric article contains an amount of lipophilic fluid that is less than the absorptive capacity, preferably less than 75% of the absorption capacity, more preferably less than 50% of the absorption capacity, even more preferably less than 30% of the absorption capacity of the fabric article. The phrase “absorption capacity of a fabric article” as used herein means the maximum quantity of fluid that can be taken in and retained by a fabric article in its pores and interstices. Absorption capacity of a fabric article is measured in accordance with the following Test Protocol for Measuring Absorption Capacity of a Fabric Article.

Test Protocol for Measuring the Absorption Capacity of a Fabric Article

Step 1: Rinse and dry a reservoir or other container into which a lipophilic fluid will be added. The reservoir is cleaned to free it from all extraneous matter, particularly soaps, detergents and wetting agents.

Step 2: Weigh a “dry” fabric article to be tested to obtain the “dry” fabric article's weight.

Step 3: Pour 2L of a lipophilic fluid at ˜20C into the reservoir.

Step 4: Place fabric article from Step 2 into the lipophilic fluid-containing reservoir.

Step 5: Agitate the fabric article within the reservoir to ensure no air pockets are left inside the fabric article and it is thoroughly wetted with the lipophilic fluid.

Step 6: Remove the fabric article from the lipophilic fluid-containing reservoir.

Step 7: Unfold the fabric article, if necessary, so that there is no contact between same or opposite fabric article surfaces.

Step 8: Let the fabric article from Step 7 drip until the drop frequency does not exceed 1 drop/sec.

Step 9: Weigh the “wet” fabric article from Step 8 to obtain the “wet” fabric article's weight.

Step 10: Calculate the amount of lipophilic fluid absorbed for the fabric article using the equation below.

FA=(W−D)/D* 100

where:

FA=fluid absorbed, % (i.e., the absorption capacity of the fabric article in terms of % by dry weight of the fabric article)

W=wet specimen weight, g

D=initial specimen weight, g

The term “high vapor pressure co-solvent” is intended to mean a co-solvent that has a vapor pressure greater than the vapor pressure of a lipophilic fluid. Typically, such co-solvents will have a vapor pressure of at least about 3 mm Hg at 20° C.

Treatment Fluids

Treatment fluids or adjuncts can vary widely and can be used at widely ranging levels. For example, detersive enzymes such as proteases, amylases, cellulases, lipases, and the like as well as bleach catalysts including the macrocyclic types having manganese or similar transition metals all useful in laundry and cleaning products can be used herein at very low, or less commonly, higher levels. Adjuncts that are catalytic, for example enzymes, can be used in “forward” or “reverse” modes, a discovery independently useful from the specific appliances of the present invention. For example, a lipolase or other hydrolase may be used, optionally in the presence of alcohols as adjuncts, to convert fatty acids to esters, thereby increasing their solubility in the lipohilic fluid. This is a “reverse” operation, in contrast with the normal use of this hydrolase in water to convert a less water-soluble fatty ester to a more water-soluble material. In any event, any adjunct must be suitable for use in combination with the present invention.

Some suitable adjuncts include, but are not limited to, builders, surfactants, enzymes, emulsifiers, bleach activators, bleach catalysts, bleach boosters, bleaches, alkalinity sources, antibacterial agents, colorants, perfumes, pro-perfumes, finishing aids, lime soap dispersants, composition malodor control agents, odor neutralizers, polymeric dye transfer inhibiting agents, crystal growth inhibitors, photobleaches, heavy metal ion sequestrants, anti-tarnishing agents, anti-microbial agents, anti-oxidants, anti-redeposition agents, soil release polymers, electrolytes, pH modifiers, thickeners, abrasives, divalent or trivalent ions, metal ion salts, enzyme stabilizers, corrosion inhibitors, diamines or polyamines and/or their alkoxylates, suds stabilizing polymers, solvents, process aids, fabric softening agents, optical brighteners, hydrotropes, suds or foam suppressors, suds or foam boosters, fabric softeners, antistatic agents, dye fixatives, dye abrasion inhibitors, anti-crocking agents, wrinkle reduction agents, wrinkle resistance agents, fabric-pressing starch, soil release polymers, soil repellency agents, sunscreen agents, anti-fade agents, waterproofing agents, stainproofing agents, and mixtures thereof.

The term “surfactant” conventionally refers to materials that are surface-active either in the water, lipophilic fluid, or the mixture of the two. Some illustrative surfactants include nonionic, cationic and silicone surfactants as used in conventional aqueous detergent systems. Suitable nonionic surfactants include, but are not limited to:

a) polyethylene oxide condensates of nonyl phenol and myristyl alcohol, such as in U.S. Pat. No. 4,685,930 Kasprzak; and

b) fatty alcohol ethoxylates, R—(OCH₂CH₂)ₐOH a=1 to 100, typically 12-40, R=hydrocarbon residue 8 to 20 C atoms, typically linear alkyl. Examples polyoxyethylene lauryl ether, with 4 or 23 oxyethylene groups; polyoxyethylene cetyl ether with 2, 10 or 20 oxyethylene groups; polyoxyethylene stearyl ether, with 2, 10, 20, 21 or 100 oxyethylene groups; polyoxyethylene (2), (10) oleyl ether, with 2 or 10 oxyethylene groups. Commercially available examples include, but are not limited to: ALFONIC, BRIJ, GENAPOL, NEODOL, SURFONIC, TRYCOL. See also U.S. Pat. No. 6,013,683 Hill, et al.

Suitable cationic surfactants include, but are not limited to dialkyldimethylammonium salts having the formula:

R′R″N⁺(CH₃)₂X⁻

Where each R′R″ is independently selected from the group consisting of 12-30 C atoms or derived from tallow, coconut oil or soy, X═Cl or Br, Examples include: didodecyldimethylammonium bromide (DDAB), dihexadecyldimethyl ammonium chloride, dihexadecyldimethyl ammonium bromide, dioctadecyldimethyl ammonium chloride, dieicosyldimethyl ammonium chloride, didocosyldimethyl ammonium chloride, dicoconutdimethyl ammonium chloride, ditallowdimethyl ammonium bromide (DTAB). Commercially available examples include, but are not limited to: ADOGEN, ARQUAD, TOMAH, VARIQUAT. See also U.S. Pat. No. 6,013,683 Hill et al.

Suitable silicone surfactants include, but are not limited to the polyalkyleneoxide polysiloxanes having a dimethyl polysiloxane hydrophobic moiety and one or more hydrophilic polyalkylene side chains and have the general formula:

R¹—(CH₃)₂SiO—[(CH₃)₂SiO]ₐ—[(CH₃)(R¹)SiO]_{b}—Si(CH₃)₂—R¹

wherein a+b are from about 1 to about 50, preferably from about 3 to about 30, more preferably from about 10 to about 25, and each R¹ is the same or different and is selected from the group consisting of methyl and a poly(ethyleneoxide/propyleneoxide) copolymer group having the general formula:

—(CH₂)ₙO(C₂H₄O)_{c}(C₃H₆O)_{d}R²

with at least one R¹ being a poly(ethyleneoxide/propyleneoxide) copolymer group, and wherein n is 3 or 4, preferably 3; total c (for all polyalkyleneoxy side groups) has a value of from 1 to about 100, preferably from about 6 to about 100; total d is from 0 to about 14, preferably from 0 to about 3; and more preferably d is 0; total c+d has a value of from about 5 to about 150, preferably from about 9 to about 100 and each R² is the same or different and is selected from the group consisting of hydrogen, an alkyl having 1 to 4 carbon atoms, and an acetyl group, preferably hydrogen and methyl group. Examples of these surfactants may be found in U.S. Pat. No. 5,705,562 Hill and U.S. Pat. No. 5,707,613 Hill.

Examples of this type of surfactants are the Silwet® surfactants which are available CK Witco, OSi Division, Danbury, Conn. Representative Silwet surfactants are as follows.

| Name | Average MW | Average a + b | Average total c |
|---|---|---|---|
| L-7608 | 600 | 1 | 9 |
| L-7607 | 1,000 | 2 | 17 |
| L-77 | 600 | 1 | 9 |
| L-7605 | 6,000 | 20 | 99 |
| L-7604 | 4,000 | 21 | 53 |
| L-7600 | 4,000 | 11 | 68 |
| L-7657 | 5,000 | 20 | 76 |
| L-7602 | 3,000 | 20 | 29 |

The molecular weight of the polyalkyleneoxy group (R¹) is less than or equal to about 10,000. Preferably, the molecular weight of the polyalkyleneoxy group is less than or equal to about 8,000, and most preferably ranges from about 300 to about 5,000. Thus, the values of c and d can be those numbers which provide molecular weights within these ranges. However, the number of ethyleneoxy units (—C₂H₄O) in the polyether chain (R¹) must be sufficient to render the polyalkyleneoxide polysiloxane water dispersible or water soluble. If propyleneoxy groups are present in the polyalkylenoxy chain, they can be distributed randomly in the chain or exist as blocks. Preferred Silwet surfactants are L-7600, L-7602, L-7604, L-7605, L-7657, and mixtures thereof. Besides surface activity, polyalkyleneoxide polysiloxane surfactants can also provide other benefits, such as antistatic benefits, and softness to fabrics.

The preparation of polyalkyleneoxide polysiloxanes is well known in the art. Polyalkyleneoxide polysiloxanes of the present invention can be prepared according to the procedure set forth in U.S. Pat. No. 3,299,112.

Another suitable silicone surfactant is SF-1488, which is available from GE silicone fluids.

These and other surfactants suitable for use in combination with the lipophilic fluid as adjuncts are well known in the art, being described in more detail in Kirk Othmer's Encyclopedia of Chemical Technology, 3rd Ed., Vol. 22, pp. 360-379, “Surfactants and Detersive Systems.” Further suitable nonionic detergent surfactants are generally disclosed in U.S. Pat. No. 3,929,678, Laughlin et al., issued Dec. 30, 1975, at column 13, line 14 through column 16, line 6.

The adjunct may also be an antistatic agent. Any suitable well-known antistatic agents used in laundering and dry cleaning art are suitable for use in the methods and compositions of the present invention. Especially suitable as antistatic agents are the subset of fabric softeners which are known to provide antistatic benefits. For example those fabric softeners which have a fatty acyl group which has an iodine value of above 20, such as N,N-di(tallowoyl-oxy-ethyl)-N,N-dimethyl ammonium methylsulfate. However, it is to be understood that the term antistatic agent is not to be limited to just this subset of fabric softeners and includes all antistatic agents.

The adjunct may also be an emulsifier. Emulsifiers are well known in the chemical art. Essentially, an emulsifier acts to bring two or more insoluble or semi-soluble phases together to create a stable or semi-stable emulsion. It is preferred in the claimed invention that the emulsifier serves a dual purpose wherein it is capable of acting not only as an emulsifier but also as a treatment performance booster. For example, the emulsifier may also act as a surfactant thereby boosting cleaning performance. Both ordinary emulsifiers and emulsifier/surfactants are commercially available.

Lipophilic Fluid

The lipophilic fluid herein is one having a liquid phase present under operating conditions of a fabric article treating appliance, in other words, during treatment of a fabric article in accordance with the present invention. In general such a lipophilic fluid can be fully liquid at ambient temperature and pressure, can be an easily melted solid, e.g., one which becomes liquid at temperatures in the range from about 0 deg. C to about 60 deg. C, or can comprise a mixture of liquid and vapor phases at ambient temperatures and pressures, e.g., at 25 deg. C and 1 atm. pressure. Thus, the lipophilic fluid is not a compressible gas such as carbon dioxide.

It is preferred that the lipophilic fluids herein be nonflammable or have relatively high flash points and/or low VOC (volatile organic compound) characteristics, these terms having their conventional meanings as used in the dry cleaning industry, to equal or, preferably, exceed the characteristics of known conventional dry cleaning fluids.

Moreover, suitable lipophilic fluids herein are readily flowable and nonviscous.

In general, lipophilic fluids herein are required to be fluids capable of at least partially dissolving sebum or body soil as defined in the test hereinafter. Mixtures of lipophilic fluid are also suitable, and provided that the requirements of the Lipophilic Fluid Test, as described below, are met, the lipophilic fluid can include any fraction of dry-cleaning solvents, especially newer types including fluorinated solvents, or perfluorinated amines. Some perfluorinated amines such as perfluorotributylamines while unsuitable for use as lipophilic fluid may be present as one of many possible adjuncts present in the lipophilic fluid-containing composition.

Other suitable lipophilic fluids include, but are not limited to, diol solvent systems e.g., higher diols such as C6- or C8- or higher diols, organosilicone solvents including both cyclic and acyclic types, and the like, and mixtures thereof.

A preferred group of nonaqueous lipophilic fluids suitable for incorporation as a major component of the compositions of the present invention include low-volatility nonfluorinated organics, silicones, especially those other than amino functional silicones, and mixtures thereof. Low volatility nonfluorinated organics include for example OLEAN® and other polyol esters, or certain relatively nonvolatile biodegradable mid-chain branched petroleum fractions.

Another preferred group of nonaqueous lipophilic fluids suitable for incorporation as a major component of the compositions of the present invention include, but are not limited to, glycol ethers, for example propylene glycol methyl ether, propylene glycol n-propyl ether, propylene glycol t-butyl ether, propylene glycol n-butyl ether, dipropylene glycol methyl ether, dipropylene glycol n-propyl ether, dipropylene glycol t-butyl ether, dipropylene glycol n-butyl ether, tripropylene glycol methyl ether, tripropylene glycol n-propyl ether, tripropylene glycol t-butyl ether, tripropylene glycol n-butyl ether. Suitable silicones for use as a major component, e.g., more than 50%, of the composition include cyclopentasiloxanes, sometimes termed “D5”, and/or linear analogs having approximately similar volatility, optionally complemented by other compatible silicones. Suitable silicones are well known in the literature, see, for example, Kirk Othmer's Encyclopedia of Chemical Technology, and are available from a number of commercial sources, including General Electric, Toshiba Silicone, Bayer, and Dow Corning. Other suitable lipophilic fluids are commercially available from Procter & Gamble or from Dow Chemical and other suppliers.

Qualification of Lipophilic Fluid and Lipophilic Fluid Test (LF Test)

Any nonaqueous fluid that is both capable of meeting known requirements for a dry-cleaning fluid (e.g, flash point etc.) and is capable of at least partially dissolving sebum, as indicated by the test method described below, is suitable as a lipophilic fluid herein. As a general guideline, perfluorobutylamine (Fluorinert FC-43®) on its own (with or without adjuncts) is a reference material which by definition is unsuitable as a lipophilic fluid for use herein (it is essentially a nonsolvent) while cyclopentasiloxanes have suitable sebum-dissolving properties and dissolves sebum.

The following is the method for investigating and qualifying other materials, e.g., other low-viscosity, free-flowing silicones, for use as the lipophilic fluid. The method uses commercially available Crisco (canola oil, oleic acid (95% pure, available from Sigma Aldrich Co.) and squalene (99% pure, available from J. T. Baker) as model soils for sebum. The test materials should be substantially anhydrous and free from any added adjuncts, or other materials during evaluation.

Prepare three vials, each vial will contain one type of lipophilic soil. Place 1.0 g of canola oil in the first; in a second vial place 1.0 g of the oleic acid (95%), and in a third and final vial place 1.0 g of the squalene (99.9%). To each vial add 1 g of the fluid to be tested for lipophilicity. Separately mix at room temperature and pressure each vial containing the lipophilic soil and the fluid to be tested for 20 seconds on a standard vortex mixer at maximum setting. Place vials on the bench and allow to settle for 15 minutes at room temperature and pressure. If, upon standing, a clear single phase is formed in any of the vials containing lipophilic soils, then the nonaqueous fluid qualifies as suitable for use as a “lipophilic fluid” in accordance with the present invention. However, if two or more separate layers are formed in all three vials, then the amount of nonaqueous fluid dissolved in the oil phase will need to be further determined before rejecting or accepting the nonaqueous fluid as qualified.

In such a case, with a syringe, carefully extract a 200-microliter sample from each layer in each vial. The syringe-extracted layer samples are placed in GC auto sampler vials and subjected to conventional GC analysis after determining the retention time of calibration samples of each of the three models soils and the fluid being tested. If more than 1% of the test fluid by GC, preferably greater, is found to be present in any one of the layers which consists of the oleic acid, canola oil or squalene layer, then the test fluid is also qualified for use as a lipophilic fluid. If needed, the method can be further calibrated using heptacosafluorotributylamine, i.e., Fluorinert FC-43 (fail) and cyclopentasiloxane (pass). A suitable GC is a Hewlett Packard Gas Chromatograph HP5890 Series II equipped with a split/splitless injector and FID. A suitable column used in determining the amount of lipophilic fluid present is a J&W Scientific capillary column DB-1HT, 30 meter, 0.25 mm id, 0.1 um film thickness cat# 1221131. The GC is suitably operated under the following conditions:

Carrier Gas: Hydrogen

Column Head Pressure: 9 psi

Flows: Column Flow @ ˜1.5 ml/min.

Split Vent @ ˜250-500 ml/min.

Septum Purge @ 1 ml/min.

Injection: HP 7673 Autosampler, 10 ul syringe, 1 ul injection

Injector Temperature: 350° C.

Detector Temperature: 380° C.

Oven Temperature Program: initial 60° C. hold 1 min.

rate 25° C./min.

final 380° C. hold 30 min.

Preferred lipophilic fluids suitable for use herein can further be qualified for use on the basis of having an excellent garment care profile. Garment care profile testing is well known in the art and involves testing a fluid to be qualified using a wide range of garment or fabric article components, including fabrics, threads and elastics used in seams, etc., and a range of buttons. Preferred lipophilic fluids for use herein have an excellent garment care profile, for example they have a good shrinkage and/or fabric puckering profile and do not appreciably damage plastic buttons. Certain materials which in sebum removal qualify for use as lipophilic fluids, for example ethyl lactate, can be quite objectionable in their tendency to dissolve buttons, and if such a material is to be used in the compositions of the present invention, it will be formulated with water and/or other solvents such that the overall mix is not substantially damaging to buttons. Other lipophilic fluids, D5, for example, meet the garment care requirements quite admirably. Some suitable lipophilic fluids may be found in granted U.S. Pat. Nos. 5,865,852; 5,942,007; 6,042,617; 6,042,618; 6,056,789; 6,059,845; and 6,063,135, which are incorporated herein by reference.

Lipophilic fluids can include linear and cyclic polysiloxanes, hydrocarbons and chlorinated hydrocarbons, with the exception of PERC which is explicitly not covered by the lipophilic fluid definition as used herein. (Specifically call out DF2000 and PERC). More preferred are the linear and cyclic polysiloxanes and hydrocarbons of the glycol ether, acetate ester, lactate ester families. Preferred lipophilic fluids include cyclic siloxanes having a boiling point at 760 mm Hg. of below about 250° C. Specifically preferred cyclic siloxanes for use in this invention are octamethylcyclotetrasiloxane, decamethylcyclopentasiloxane, and dodecamethylcyclohexasiloxane. Preferably, the cyclic siloxane comprises decamethylcyclopentasiloxane (D5, pentamer) and is substantially free of octamethylcyclotetrasiloxane (tetramer) and dodecamethylcyclohexasiloxane (hexamer).

However, it should be understood that useful cyclic siloxane mixtures might contain, in addition to the preferred cyclic siloxanes, minor amounts of other cyclic siloxanes including octamethylcyclotetrasiloxane and hexamethylcyclotrisiloxane or higher cyclics such as tetradecamethylcycloheptasiloxane. Generally the amount of these other cyclic siloxanes in useful cyclic siloxane mixtures will be less than about 10 percent based on the total weight of the mixture. The industry standard for cyclic siloxane mixtures is that such mixtures comprise less than about 1% by weight of the mixture of octamethylcyclotetrasiloxane.

Accordingly, the lipophilic fluid of the present invention preferably comprises more than about 50%, more preferably more than about 75%, even more preferably at least about 90%, most preferably at least about 95% by weight of the lipophilic fluid of decamethylcyclopentasiloxane. Alternatively, the lipophilic fluid may comprise siloxanes which are a mixture of cyclic siloxanes having more than about 50%, preferably more than about 75%, more preferably at least about 90%, most preferably at least about 95% up to about 100% by weight of the mixture of decamethylcyclopentasiloxane and less than about 10%, preferably less than about 5%, more preferably less than about 2%, even more preferably less than about 1%, most preferably less than about 0.5% to about 0% by weight of the mixture of octamethylcyclotetrasiloxane and/or dodecamethylcyclohexasiloxane.

The level of lipophilic fluid, when present in the lipophilic fluid based fabric treating compositions according to the present invention, is preferably from about 70% to about 99.99%, more preferably from about 90% to about 99.9%, and even more preferably from about 95% to about 99.8% by weight of the lipophilic fluid based fabric treating composition.

Drying Time Reduction

The present invention is directed to a method to reduce the time required to dry fabrics that have been cleaned or treated with a lipophilic fluid. The present invention is also directed to a system capable of performing any of methods described hereinafter. The rinse liquor may be neat lipophilic fluid or lipophilic fluid with additives for finishing, faster drying, and treatment. As discussed before, the invention is to heat fabrics contacted with a lipophilic fluid to a temperature above ambient temperature by utilizing at least one of three steps or a combination of the steps.

One possible step is to blow a gas, preferably a gas heated to temperatures above ambient, onto the fabrics while spraying the liquor used to rinse the fabrics and tumbling the fabrics. The essence of this step is to preheat the fabrics and the rinse liquor prior to the beginning of fabric drying in order to save this preheat time during the drying cycle. Drycleaners do not typically preheat the rinse liquor or clothes since it provides little, if any, cleaning benefit. Further, drycleaners are not typically concerned with drying time falling into the range of drying time expected in the home. Drycleaners also typically use solvents with lower boiling points or can exceed flash point temperatures during drying since most of their equipment operates at reduced oxygen levels (less than about 8% O₂ in air) during drying which reduces any flash or fire risk. It is important to perform this step prior to extracting the rinse liquor (spin cycle) or there will be no drying time saved by utilizing the step.

Another possible step is pre-heating the rinse liquor prior to applying it to the fabrics. Again, drycleaners do not typically preheat rinse liquors prior to application for the same reasons outlined above. This step is similar to the step above except that the rinse liquor is heated separately from the fabrics and the fabrics themselves are not heated until the warm rinse liquor contacts the fabrics.

The last of the three inventive steps is exposing the fabrics to an electromagnetic energy source while spraying rinse liquor onto and tumbling the fabrics but prior to extracting the rinse liquor. The electromagnetic energy source can be selected from at least one of infrared light, microwave, and radio frequency. This step is essentially the same as the first outlined above; however, rather than use a heated gas, the drying energy is derived from an electromagnetic source. Electromagnetic dryers are commercially available from companies including Microdry Corporation in Kentucky and Radio Frequency Incorporated in Massachusetts.

An optional step in addition to at least one of those outlined above could be to expose the fabrics to a co-solvent having a higher vapor pressure than the lipophilic fluid and/or rinse liquor while still being miscible therewith. The co-solvent would preferably have a vapor pressure that is at least about 3 mm Hg at 20° C. It is also preferred that the co-solvent is selected from methylol, ethylol, butylol, ethanol, and mixtures of these co-solvents. It is also preferable that the co-solvent be non-flammable since it will be exposed to heat and the drier and particularly since the invention may be utilized in the home. Other preferred co-solvents are the hydrofluoroethers and the most preferred among them is methyl nonafluoroisobutyl ether.

Gases suitable for the present invention are preferably selected from air, nitrogen, steam, and combinations thereof. Further, it is preferred that the gas flows onto the fabrics and rinse liquor at a rate of 40 ft³/min to 250 ft³/min, preferably between 80 ft³/min and 150 ft³/min. It is also preferred that the gas be heated to at least about 10 degrees above ambient temperature.

It is also preferred that the methods of the present invention occur in a laundering apparatus that has at least one fabric spin velocity and at least one fabric spin time. It is preferred that the fabric spin velocity is at or above about 200 G, more preferably at or above about 300 G, even more preferably at or above about 400 G. Particularly preferred are fabric spin velocities at or above 400 G and fabric spin times at or above about 30 seconds.

Drying the fabrics under vacuum can also help reduce the drying time by lowering the boiling points of the lipophilic fluid or rinse liquor used during the wash cycle. Therefore, it is an optional additional step to expose the fabrics to less than about 1 atm of pressure during drying.

As stated above, the rinse liquor can contain a lipophilic fluid. Preferred lipophilic fluids for use with the present invention include linear or cyclic siloxanes with the cyclic being the most preferred between them. Decamethylcyclopentasiloxane is a particularly preferred cyclic siloxane. These and other suitable lipophilic fluids have been described in detail above. The rinse liquor can also contain finishing or treatment constituents selected from bleaches, emulsifiers, fabric softeners, perfumes, antibacterial agents, antistatic agents, brighteners, dye fixatives, dye abrasion inhibitors, anti-crocking agents, wrinkle reduction agents, wrinkle resistance agents, soil release polymers, sunscreen agents, anti-fade agents, waterproofing agents, stainproofing agents, soil repellency agents, and mixtures thereof. These and other suitable treatment aids have also been discussed above.

It will be understood that the present invention may be combined with fabric treatments. For example, prior to cleaning and drying, the fabric articles may be subjected to the particulate removal method described in co-pending application Serial No. 60/191,965, to Noyes et al., filed Mar. 24, 2000.

The present invention may be used in a service, such as a dry cleaning service, diaper service, uniform cleaning service, or commercial business, such as a laundromat, dry cleaner, linen service which is part of a hotel, restaurant, convention center, airport, cruise ship, port facility, casino, or may be used in the home.

The present invention may also be performed in an apparatus having a “contra-rotating” drum. A contra-rotating drum is a two-piece split drum wherein each half of the drum is capable of rotation in a direction opposite the other half of the drum simultaneously. The contra-rotating movement is an effective mechanism for randomly rearranging the fabric articles' positions within the drum. These apparatus are commercially available from companies such as Dyson.

The present invention may also be performed in an apparatus capable of “dual mode” functions. A “dual mode” apparatus is one capable of both washing and drying fabrics within the same drum. These apparatus are widely available, especially in Europe.

The present invention may be performed in an apparatus that is a modified existing apparatus and is retrofitted in such a manner as to conduct the process of the present invention in addition to related processes.

Finally, the present invention may also be performed in an apparatus, which is not a modified existing apparatus but is one specifically built in such a manner so as to conduct the process of the present invention. This would include all the associated plumbing, such as connection to a chemical and/or gas supply, and sewerage for waste fluids.

An apparatus used in the processes of the present invention will typically contain some type of control system. These include electrical systems, such as, the so-called smart control systems, as well as more traditional electromechanical systems. The control systems could enable the user to select the size of the fabric load to be dried, the extent of drying, and/or the time for the drying cycle cycle. Alternatively, the user could use pre-set drying cycles, or the apparatus could control the length of the drying cycle, based on any number of ascertainable parameters including, but not limited to, the lipophilic fluid vapor content of the drum. This would be especially true for electrical control systems.

In the case of electrical control systems, one option is to make the control device a so-called “smart device”. This could mean including, but not limited to, self diagnostic system, load type and cycle selection, linking the machine to the Internet and allowing for the consumer to start the apparatus remotely, be informed when the apparatus has treated and dried a fabric article, or for the supplier to remotely diagnose problems if the apparatus should break down. Furthermore, if the apparatus of the present invention is only a part of a cleaning system, the so called “smart system” could be communicating with the other cleaning devices which would be used to complete the remainder of the cleaning process, such as a washing machine, and a dryer.

What is claimed is:

1. A method for drying lipophilic fluid-containing fabric articles comprising a step selected from the group consisting of:
a. adding a high vapor pressure co-solvent to the lipophilic fluid prior to contacting the fabric articles with the lipophilic fluid;
b. adding heat to the lipophilic fluid prior to contacting the fabric articles with the lipophilic fluid;
c. subjecting the lipophilic fluid-containing fabric articles to heat;
d. subjecting the lipophilic fluid-containing fabric articles to a vacuum;
e. subjecting the lipophilic fluid-containing fabric articles to a fabric article spin velocity of at least about 200 G;
f. subjecting the lipophilic fluid-containing fabric articles to a high vapor pressure co-solvent; and
g. mixtures thereof.

2. The method according to claim 1 wherein the high vapor pressure co-solvent is miscible in the lipophilic fluid.

3. The method according to claim 1 wherein the high vapor pressure co-solvent has a vapor pressure of from at least about 3 mm Hg at 20° C.

4. The method according to claim 1 wherein said high vapor pressure co-solvent is selected from the group consisting essentially of: methyol, ethylol, butylol, ethanol, hydrofluoroethers and mixtures thereof.

5. The method according to claim 1 wherein said step of adding heat to the lipophilic fluid comprises subjecting the lipophilic fluid to heat from a heat source such that lipophilic fluid achieves a temperature above ambient temperature.

6. The method according to claim 1 wherein said step of subjecting the lipophilic fluid-containing fabric articles to heat comprises subjecting the lipophilic fluid-containing fabric articles to heat from a heat source such that the lipophilic fluid-containing fabric articles achieve a temperature above ambient temperature.

7. The method according to claim 6 wherein the step of subjecting the lipophilic fluid-containing fabric articles to heat comprises blowing heated gas onto the lipophilic fluid-containing fabric articles.

8. The method according to claim 7 wherein said gas is selected from the group consisting essentially of air, nitrogen, steam, and combinations thereof.

9. The method according to claim 7 wherein said gas blows onto said fabric articles at a rate of 40 ft³/min to 250 ft³/min.

10. The method according to claim 6 wherein the step of subjecting the lipophilic fluid-containing fabric articles to heat comprises exposing the lipophilic fluid-containing fabric articles to electromagnetic energy.

11. The method according to claim 6 wherein the step of subjecting the lipophilic fluid-containing fabric articles to heat comprises contacting the lipophilic fluid-containing fabric articles with a rinse liquor that is at a temperature above ambient temperature.

12. The method according to claim 11 wherein said rinse liquor comprises a lipophilic fluid.

13. The method according to claim 12 wherein said lipophilic fluid comprises a cyclic siloxane.

14. The method according to claim 11 wherein said rinse liquor comprises a constituent selected from bleaches, emulsifiers, fabric softeners, perfumes, antibacterial agents, antistatic agents, brighteners, dye fixatives, dye abrasion inhibitors, anti-crocking agents, wrinkle reduction agents, wrinkle resistance agents, soil release polymers, sunscreen agents, anti-fade agents, waterproofing agents, stainproofing agents, soil repellency agents, and mixtures thereof.

15. The method according to claim 1 wherein said step of subjecting the lipophilic fluid-containing fabric articles to a vacuum comprises subjecting the lipophilic fluid-containing fabric articles to a pressure of less than about 1 atm.

16. The method according to claim 1 wherein said step of subjecting the lipophilic fluid-containing fabric articles to a fabric article spin velocity of at least about 200 G comprises subjecting the lipophilic fluid-containing fabric articles to a fabric article spin velocity of at least about 300 G.

17. The method according to claim 1 wherein said step of subjecting the lipophilic fluid-containing fabric articles to a fabric article spin velocity of at least about 200 G comprises subjecting the lipophilic fluid-containing fabric articles to a fabric article spin velocity of at least about 200 G for at least about 30 seconds.

18. The method according to claim 1 wherein said lipophilic fluid comprises a cyclic siloxane.

19. The method according to claim 1 wherein said lipophilic fluid comprises a constituent selected from bleaches, emulsifiers, fabric softeners, perfumes, antibacterial agents, antistatic agents, brighteners, dye fixatives, dye abrasion inhibitors, anti-crocking agents, wrinkle reduction agents, wrinkle resistance agents, soil release polymers, sunscreen agents, anti-fade agents, waterproofing agents, stainproofing agents, soil repellency agents, and mixtures thereof.

20. A lipophilic fluid-containing fabric article treated by the method according to claim 1.

21. A system for drying lipophilic fluid-containing fabric articles comprising subjecting the lipophilic fluid-containing fabric articles to at least one of the following conditions:
a. heat above ambient temperature;
b. vacuum;
c. spin velocity of at least about 200 G;
such that the lipophilic fluid-containing fabric articles are dried.

22. A lipophilic fluid-containing fabric article treated by the system according to claim 21.
